(19) United States
(12) Patent Application Publication
(10) Pub. No.: US 2024/0092445 A1
(43) Pub. Date: Mar. 21, 2024

(54) ELECTRIC STRADDLED VEHICLE

(71) Applicant: YAMAHA HATSUDOKI KABUSHIKI KAISHA, Iwata-shi (JP)

(72) Inventor: Shidehiko MIYASHIRO, Shizuoka (JP)

(21) Appl. No.: 18/468,014

(22) Filed: Sep. 15, 2023

(30) Foreign Application Priority Data
Sep. 20, 2022 (JP) 2022-149063

(51) Int. Cl. B62J 43/16; B62J 43/28; B62M 7/06

(52) U.S. Cl. CPC B62J 43/16; B62J 43/28; B62M 7/06

(57) ABSTRACT

An electric straddled vehicle includes an electric component, a case, a breather hose, and a cap. The case accommodates the electric component. The breather hose has a first end and a second end that are opposite to each other, the first end being connected to the case. The cap is breathable and waterproof, and is attached to the second end of the breather hose.

### CROSS-REFERENCE TO RELATED APPLICATIONS

This application is based on, and claims priority from, Japanese Patent Application No. 2022-149063, filed on Sep. 20, 2022. The contents of the application is incorporated herein by reference.

### BACKGROUND

### Field of the Invention

The present invention relates to an electric straddled vehicle.

### Background Information

There has been conventionally known a type of electric straddled vehicle that includes a case for accommodating a battery, an intake pipe for taking air into the case, and a discharge pipe for discharging gas from the interior of the case (see Japan Laid-open Patent Application Publication No. 2021-133711).

When the electric straddled vehicle disclosed in Japan Laid-open Patent Application Publication No. 2021-133711 is submerged to the vicinity of an opening of the intake pipe, for instance, it is concerned that water intrudes into the case through the opening of the intake pipe.

It is an object of the present invention to provide an electric straddled vehicle that elevation in internal pressure of a case for accommodating an electric component and intrusion of water into the case can be inhibited.

### SUMMARY

An electric straddled vehicle according to an aspect of the present invention includes an electric component, a case, a breather hose, and a cap. The case accommodates the electric component. The breather hose includes a first end connected to the case and a second end provided on an opposite side of the first end. The cap having breathable waterproof properties, is attached to the second end of the breather hose.

In the electric straddled vehicle according to the present aspect, the cap, having breathable waterproof properties, is attached to the breather hose; hence, elevation in internal pressure of the case can be inhibited by the breather hose, while intrusion of water into the case through the breather hose can be inhibited.

The second end of the breather hose may be disposed further on an upper side than the case. In this case, when the case is submerged or when the vehicle is washed by high-pressure water, the cap can be inhibited from getting wet by the water; hence, intrusion of the water into the case through the second end of the breather hose can be inhibited. Besides, the cap can be inhibited from being immersed in muddy water in traveling; hence, deterioration in water permeability of the cap can be inhibited.

The electric straddled vehicle may further include a seat on which an operator is seated. The second end of the breather hose may be disposed further on an upper side than a lower end of the seat. In this case, when the case is submerged or when the vehicle is washed by high-pressure water, the cap can be inhibited from getting wet by the water; hence, intrusion of the water into the case through the second end of the breather hose can be inhibited. Besides, the cap can be inhibited from being immersed in muddy water in traveling; hence, deterioration in water permeability of the cap can be inhibited.

The electric straddled vehicle may further include a front wheel. The second end of the breather hose may be disposed further on an upper side than the front wheel. In this case, when the case is submerged or when the vehicle is washed by high-pressure water, the cap can be inhibited from getting wet by the water; hence, intrusion of the water into the case through the second end of the breather hose can be inhibited. Besides, the cap can be inhibited from being immersed in muddy water in traveling; hence, deterioration in water permeability of the cap can be inhibited.

The electric straddled vehicle may further include a rear wheel. The second end of the breather hose may be disposed further on an upper side than the rear wheel. In this case, when the case is submerged or when the vehicle is washed by high-pressure water, the cap can be inhibited from getting wet by the water; hence, intrusion of the water into the case through the second end of the breather hose can be inhibited. Besides, the cap can be inhibited from being immersed in muddy water in traveling; hence, deterioration in water permeability of the cap can be inhibited.

The electric component may be a power unit including an electric motor and a reducer. In this case, elevation in internal pressure can be inhibited in the case in which a high voltage component is accommodated, while the high voltage component can be inhibited from being immersed in water.

The case may have waterproof properties. In this case, intrusion of water into the case can be inhibited.

The cap may include a pipe, a breathable waterproof sheet, and a lid. The pipe may include a through hole and be attached to the second end of the breather hose. The breathable waterproof sheet may close the through hole of the pipe. The lid may be fixed to the pipe and cover at least a portion of the breathable waterproof sheet. In this case, elevation in internal pressure of the case for accommodating the electric component and intrusion of water into the case can be inhibited with a simple configuration.

Overall, according to the present invention, elevation in internal pressure of a case for accommodating an electric component and intrusion of water into the case can be inhibited in an electric straddled vehicle.

### BRIEF DESCRIPTION OF THE DRAWINGS

FIG. 1 is a side view of an electric straddled vehicle.

FIG. 2 is a plan view of the electric straddled vehicle.

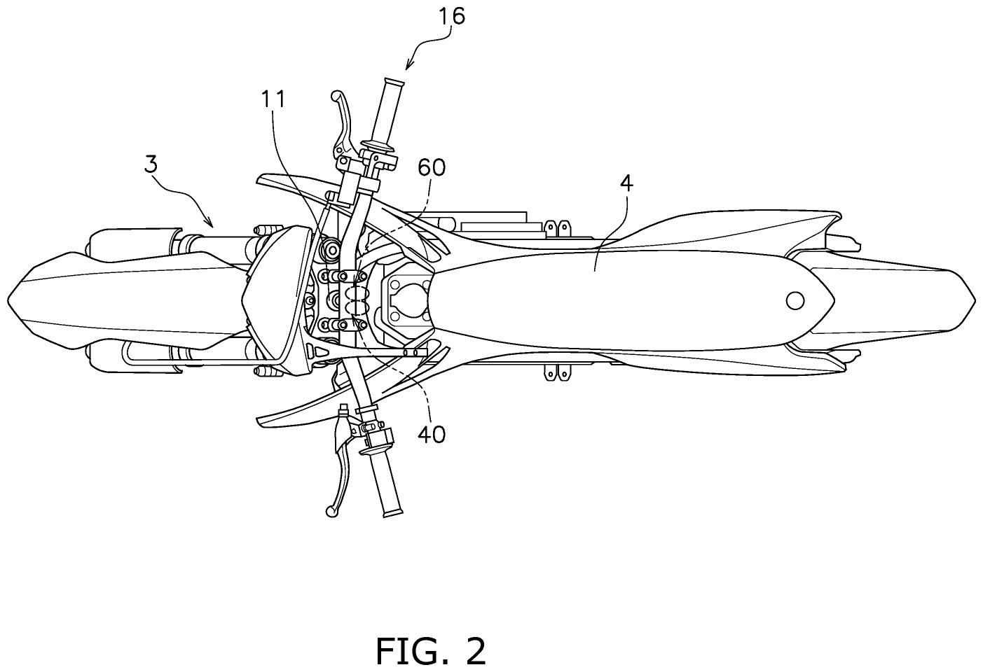

FIG. 3 is a diagram schematically showing a cross section of a cap and the surroundings thereof.

### DETAILED DESCRIPTION OF EMBODIMENTS

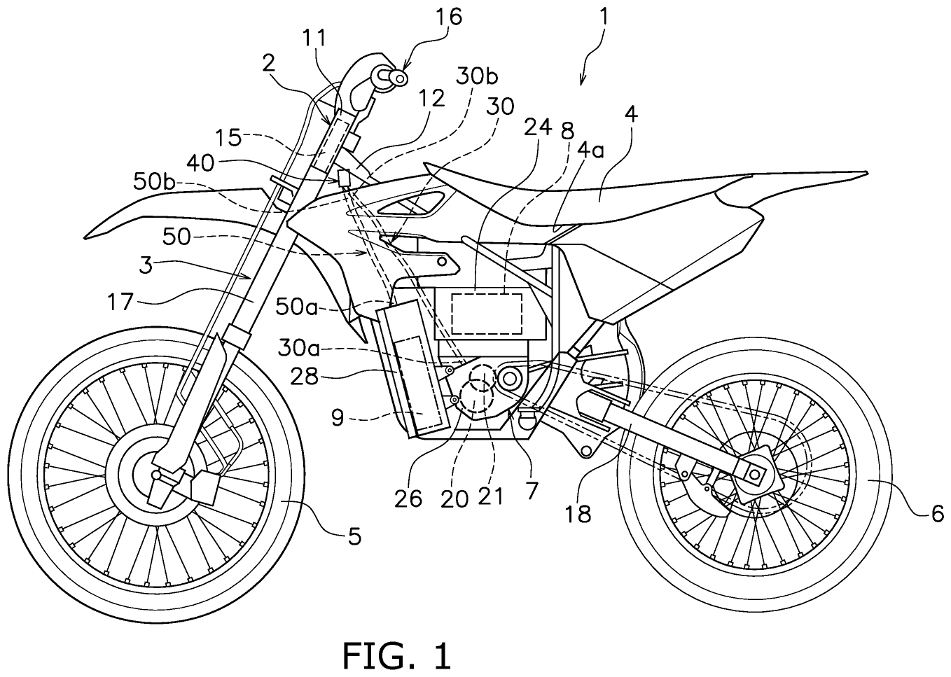

An electric straddled vehicle according to a preferred embodiment will be hereinafter explained with reference to drawings. As shown in FIG. 1, a straddled vehicle 1 is a straddled vehicle of an off-road type. It should be noted that in the following explanation, terms indicating such directions as “back and forth”, “up and down” and “right and left” are explained based on directions seen from a rider in operation of the straddled vehicle. For example, in the present preferred embodiment, the right-and-left direction is synonymous with a vehicle width direction.

The straddled vehicle 1 includes a vehicle body frame 2, a steering device 3, a seat 4, a front wheel 5, a rear wheel 6, a power unit 7, a battery 8, and a motor control unit 9.

The vehicle body frame 2 includes a head pipe 11 and a main frame 12. The head pipe 11 extends forward and downward from the upper end thereof to the lower end thereof in a vehicle side view. The head pipe 11 is disposed in the middle of the vehicle in the vehicle width direction. The main frame 12 is connected to the head pipe 11. The main frame 12 extends rearward from the head pipe 11.

The steering device 3 is supported by the head pipe 11 so as to be turnable. The steering device 3 supports the front wheel 5 such that the front wheel 5 is made rotatable. The steering device 3 includes a steering shaft 15, a handle member 16, and a front fork 17. The steering shaft is inserted into the head pipe 11. The handle member 16 is disposed further on the upper side than the head pipe 11 and is connected to the steering shaft 15. The front fork 17 is connected to the steering shaft 15. The front fork 17 supports the front wheel 5 such that the front wheel 5 is made rotatable.

The seat 4 is disposed behind the head pipe 11, while being disposed directly above the main frame 12. The front wheel 5 is supported by the front fork 17 so as to be rotatable. The rear wheel 6 is supported by the main frame 12 through a swing arm 18 so as to be rotatable. The rear wheel 6 is rotated by a drive force generated by the power unit 7.

The power unit 7 is an example of electric component. The power unit 7 is attached to the vehicle body frame 2. The power unit 7 drives the rear wheel 6 through, for instance, a chain. The power unit 7 includes an electric motor 20 and a reducer 21. The electric motor 20 is an example of electric component. The electric motor 20 is driven by electric power supplied thereto from the battery 8. The reducer 21 reduces the speed of rotation of the electric motor 20.

The battery 8 is disposed directly above the power unit 7. The battery 8 supplies the electric power to the electric motor 20. The battery 8 is accommodated in a battery case 24 disposed directly above the power unit 7.

The motor control unit 9 is attached to the vehicle body frame 2. The motor control unit 9 is electrically connected to the electric motor 20 so as to control the electric motor 20. For example, the motor control unit 9 includes a circuit board (not shown in the drawings) on which a processor, a memory, and so forth are mounted.

The straddled vehicle 1 further includes a first case 26, a second case 28, a breather hose 30, and a cap 40.

The first case 26 accommodates the electric motor 20 and the reducer 21. The first case 26 has waterproof properties. The second case 28 accommodates the motor control unit 9. The second case 28 has waterproof properties. The second case 28 is disposed in front of the first case 26. It should be noted that each of the first and second cases 26 and 28 is an example of case.

The breather hose 30 is made in shape of a tube. The breather hose 30 extends approximately in the up-and-down direction in the vehicle side view. The breather hose 30 is connected to the first case 26. The breather hose 30 extends from an upper portion of the first case 26 toward the head pipe 11. The breather hose 30 is disposed at least in part further on the front side than the battery case 24. The breather hose 30 is supported by, for instance, the vehicle body frame 2 through a hose clamp and/or so forth.

The breather hose 30 includes a first end 30a and a second end 30b. The first end 30a is connected to the first case 26. The second end 30b is an end provided on the opposite side of the first end 30a. The second end 30b is disposed further on the upper side than the first end 30a. The second end 30b is disposed further on the front side than the first end 30a.

The second end 30b is disposed further on the rear side than the head pipe 11, while being disposed further on the front side than the seat 4. The second end 30b is disposed further on the upper side than the first case 26. The second end 30b is disposed further on the upper side than the battery case 24. The second end 30b is disposed further on the upper side than the second case 28. The second end 30b is disposed further on the upper side than a lower end 4a of the seat 4. The second end 30b is disposed further on the upper side than the front wheel 5. The second end 30b is disposed further on the upper side than the rear wheel 6.

The cap 40 has breathable waterproof properties. The cap 40 is attached to the second end 30b of the breather hose 30. The cap 40 overlaps with the steering device 3 in a vehicle plan view. The cap 40 may be disposed further on the rear side than the steering device 3, or alternatively, may be disposed further on the rear side than a handlebar.

The cap 40 is disposed further on the rear side than the head pipe 11, while being disposed further on the front side than the seat 4. The cap 40 is disposed further on the upper side than the first case 26. The cap 40 is disposed further on the upper side than the battery case 24. The cap 40 is disposed further on the upper side than the lower end 4a of the seat 4. The cap 40 is disposed further on the upper side than the front wheel 5. The cap 40 is disposed further on the upper side than the rear wheel 6.

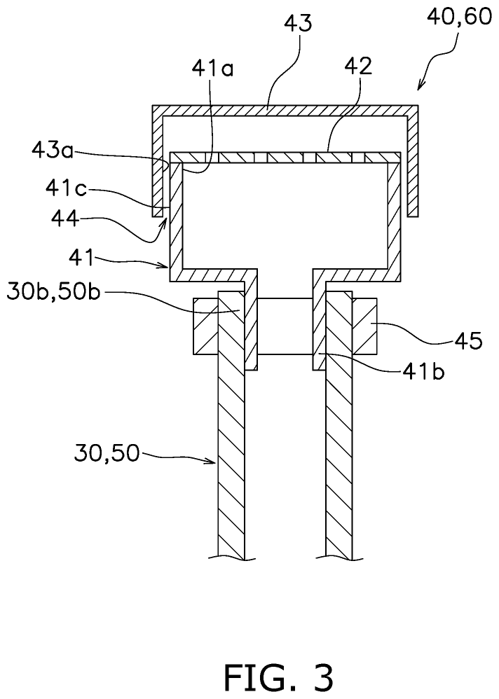

As shown in FIG. 3, the cap 40 includes a pipe 41, a breathable waterproof sheet 42, a lid 43, and a vent hole 44. The pipe 41 is made in shape of a tube and is made of, for instance, a resin material. The pipe 41 is attached to the second end 30b of the breather hose 30. The pipe 41 includes a through hole 41a and a fixed portion 41b. The through hole 41a is provided on one end of the pipe 41, whereas the fixed portion 41b is provided on the other end of the pipe 41. The through hole 41a is opened upward. The outer diameter of the fixed portion 41b is lesser than the inner diameter of the through hole 41a. The outer diameter of the fixed portion 41b is lesser than the inner diameter of the second end 30b of the breather hose 30. The fixed portion 41b is fixed to the breather hose 30 by a band member 45, while being inserted into an inner peripheral part of the second end 30b of the breather hose 30. It should be noted that the second end 30b of the breather hose 30 may be configured to be inserted and fixed into an inner peripheral part of the fixed portion 41b.

The breathable waterproof sheet 42 closes the through hole 41a of the pipe 41. The breathable waterproof sheet 42 has both breathable properties and waterproof properties. The breathable waterproof sheet 42 is configured to allow moisture to penetrate without allowing water to penetrate. The breathable waterproof sheet 42 has a feature that moisture is passed through but water is not passed through. For example, the breathable waterproof sheet 42 is a member made in shape of a film in which a large number of minute pores are perforated.

The lid 43 is made of, for instance, a resin material. The lid 43 is fixed to the one end of the pipe 41. The lid 43 covers an outer peripheral surface 41c of the one end of the pipe 41. The lid 43 is fixed to the outer peripheral surface 41c of the pipe 41. As shown in FIG. 3, a portion of an inner peripheral surface 43a of the lid 43 opposed to the outer peripheral surface 41c of the pipe 41 is separated from the outer peripheral surface 41c of the pipe 41. The lid 43 covers at least a portion of the breathable waterproof sheet 42. In the present preferred embodiment, the lid 43 covers the entirety of the breathable waterproof sheet 42. A gap is produced between the lid 43 and the breathable waterproof sheet 42.

The vent hole 44 is composed by a gap between the outer peripheral surface 41c of the pipe 41 and the inner peripheral surface 43a of the lid 43. The vent hole 44 makes the inside and the outside of the cap 40 communicate with each other therethrough.

The straddled vehicle 1 further includes a breather hose 50 and a cap 60. The breather hose 50 is connected to the second case 28. The breather hose 50 includes a first end 50a and a second end 50b. The breather hose 50 is comparable to the breather hose 30 except for a configuration of the breather hose 50 connected to the second case 28; hence, detailed explanation of the breather hose 50 will be omitted.

The cap 60 is attached to the second end 50b of the breather hose 50. The cap 60 is aligned with the cap 40 in the right-and-left direction. The cap 60 is comparable to the cap 40 except for the configuration of the cap 60 attached to the second end 50b of the breather hose 50; hence, detailed explanation of the cap 60 will be omitted.

In the straddled vehicle 1 according to the present aspect, the cap 40, having breathable waterproof properties, is attached to the breather hose 30; hence, elevation in internal pressure of the first case 26 storing the motor control unit 9 as a high voltage component can be inhibited by the breather hose 30, while intrusion of water into the first case 26 through the breather hose 30 can be inhibited.

The second end 30b of the breather hose 30 is disposed further on the upper side than the first case 26, the lower end 4a of the seat 4, the front wheel 5, and the rear wheel 6; hence, when the first case 26 is submerged or when the vehicle is washed by high-pressure water, the cap 40 can be inhibited from getting wet by the water. Accordingly, intrusion of water into the first case 26 through the second end 30b of the breather hose 30 can be inhibited. Besides, the cap 40 can be inhibited from being immersed in muddy water in traveling; hence, it is possible to inhibit occurrence of such a situation that the breathable waterproof sheet 42 of the cap 40 is clogged by the muddy water, whereby water permeability of the cap 40 is deteriorated.

It should be noted that elevation in internal pressure of the second case 28 can be inhibited by the cap 60 attached to the breather hose 50, while intrusion of water into the second case 28 through the second end 50b of the breather hose 50 can be inhibited. Besides, the cap 60 can be inhibited from being immersed in muddy water in traveling.

One preferred embodiment of the present invention has been explained above. However, the present invention is not limited to the preferred embodiment described above, and a variety of changes can be made without departing from the gist of the present invention.

In the preferred embodiment described above, the combination of the breather hose 30 and the cap 40 may be omitted from the combinations of the breather hose 30, 50 and the cap 40, 60; alternatively, the combination of the breather hose 50 and the cap 60 may be omitted therefrom.

The battery case 24 may be provided with constituent elements corresponding to the breather hose 30 and the cap 40. In this case, the battery 8 is regarded as an example of electric component.

The second end 30b of the breather hose 30 may be changed in positional arrangement. The second end 30b of the breather hose 30 may be disposed at an approximately equal height to the first case 26 in the up-and-down direction. The second end 30b of the breather hose 30 may be disposed further on the lower side than the lower end 4a of the seat 4. In a comparable manner to the above, the second end 50b of the breather hose 50 may be changed in positional arrangement.

The cap 40, 60 may be changed in shape. The lid 43 may be omitted. The vent hole 44 may be changed in shape and/or positional arrangement.

### REFERENCE SIGNS LIST

1 Straddled vehicle
4 Seat
5 Front wheel
6 Rear wheel
7 Power unit
20 Electric motor
21 Reducer
26 First case (example of case)
28 Second case (example of case)
30, 50 Breather hose
30a, 50a First end
30b, 50b Second end
40, 60 Cap
41 Pipe
41a Through hole
42 Breathable waterproof sheet
43 Lid

What is claimed is:

1. An electric straddled vehicle comprising:
an electric component;
a case accommodating the electric component;
a breather hose having a first end and a second end that are opposite to each other, the first end being connected to the case; and
a cap attached to the second end of the breather hose, the cap being breathable and waterproof.

2. The electric straddled vehicle according to claim 1, wherein the second end of the breather hose is disposed further upward than the case.

3. The electric straddled vehicle according to claim 1, further comprising:
a seat for an operator of the electric straddled vehicle to sit thereon, wherein
the second end of the breather hose is disposed further upward than a lower end of the seat.

4. The electric straddled vehicle according to claim 1, further comprising:
a front wheel, wherein
the second end of the breather hose is disposed further upward than the front wheel.

5. The electric straddled vehicle according to claim 1, further comprising:
a rear wheel, wherein
the second end of the breather hose is disposed further upward than the rear wheel.

6. The electric straddled vehicle according to claim 1, wherein the electric component is a power unit including an electric motor and a reducer.

7. The electric straddled vehicle according to claim 1, wherein the case is waterproof.

8. The electric straddled vehicle according to claim 1, wherein the cap includes
a pipe including a through hole, the pipe being attached to the second end of the breather hose,
a breathable waterproof sheet closing the through hole of the pipe, and
a lid fixed to the pipe, the lid covering at least a portion of the breathable waterproof sheet.
